(19) United States
(12) Patent Application Publication
(10) Pub. No.: US 2004/0151561 A1
(43) Pub. Date: Aug. 5, 2004

(54) Apparatus, system and method of retaining a coil spring

(75) Inventors: Bernard J. Hrytzak, Chatham (CA); Allen Tamman, Chatham (CA)

Correspondence Address: MORGAN LEWIS & BOCKIUS LLP, 1111 PENNSYLVANIA AVENUE NW, WASHINGTON, DC, 20004, US

(73) Assignee: Siemens VDO Automotive, Incorporated

(21) Appl. No.: 10/715,827

(22) Filed: Nov. 19, 2003

Related U.S. Application Data
(60) Provisional application No. 60/427,406, filed on Nov. 19, 2002.

(51) Int. Cl. F16B 43/00

(52) U.S. Cl. 411/533

(57) ABSTRACT

An apparatus, system and method for releasably retaining a helical compression spring with respect to a threaded fastener. The threaded fastener includes an annular ridge that is sized and configured to retain the helical compression spring without interfering with the operation of the helical compression spring.

### CROSS REFERENCE TO RELATED APPLICATIONS

This application claims the benefit of the earlier filing date of U.S. Provisional Application No. 60/427,406, filed 19 Nov. 2002, which is incorporated by reference herein in its entirety.

### FIELD OF THE INVENTION

According to the present invention, a coil spring is retained on a cylindrical element during an assembly process in which the position or orientation of the cylindrical element is changed. For example, a retainer according to the present invention may be used in automotive assemblies, such as electric exhaust gas recirculation valves or other components, which require pre-assembly of a coil spring and another element into a sub-assembly that is used in a subsequent assembly operation.

### BACKGROUND OF THE INVENTION

A known electric exhaust gas recirculation valve, which may be used in automotive engine combustion emission control systems, includes a coil spring and a calibration bolt that bias an armature while allowing movement of the armature.

In this known design, the coil spring is placed over the calibration bolt, and the calibration bolt is adjusted. In an automated assembly process, the calibration bolt could be inverted such that the coil spring would be prone to fall off the calibration bolt.

Thus, it would be advantageous to provide an apparatus, system and method to retain the coil spring with respect to the calibration bolt.

### SUMMARY OF THE INVENTION

The present invention provides a retaining system that includes first and second elements. The first element includes a body that extends along a longitudinal axis between first and second end portions. The body has at the first end portion a first maximum outside dimension measured perpendicular to the longitudinal axis, and has at the second end portion a second maximum outside dimension measured perpendicular to the longitudinal axis. The second maximum outside dimension is greater than the first maximum outside dimension. The body also includes a band that generally surrounds the longitudinal axis at an intermediate portion between the first and second end portions. The band has a first lateral surface that generally faces the first end portion, a second lateral surface that generally faces the second end portion, and a crest between the first and second lateral surfaces. The crest defines a third maximum outside dimension that is greater than the first maximum outside dimension and that is less than the second maximum outside dimension. The second element is adapted to extend along the longitudinal axis and to surround the body. The second element includes a first section that is proximate the first end portion, a second section that is adapted to abut the second end portion, and an intermediate section that extends between and resiliently couples the first and second sections. The intermediate section is adapted to overly the band only at one position.

The present invention also provides a retainer for loosely holding along a longitudinal axis a helical compression spring with respect to a threaded fastener. The helical compression spring includes generally closed first and second ends that are generally parallel to one another, and includes at least a portion of a coil that has a pitch measured along the longitudinal axis. The coil couples together the first and second ends. And the first end has an inside diameter. The threaded fastener includes a threaded section, a head, and a shank that couples the threaded section and the head. The threaded section and the shank have outside diameters that are less than the inside diameter of the first end. The retainer includes an annular ridge that projects from the shank. The annular ridge includes a first lateral surface that generally confronts the head, a second lateral surface that generally faces the threaded section, and a crest that is spaced along the longitudinal axis between the first and second lateral surfaces. The crest defines a maximum ridge diameter and is greater than the inside diameter of the first end of the helical compression spring.

The present invention also provides a method of releasably retaining along a longitudinal axis a helical compression spring with respect to a threaded fastener. The helical compression spring includes generally closed first and second ends that are generally parallel to one another and includes at least a portion of a coil that has a pitch along the longitudinal axis. The coil couples the first and second ends, and the first end has an inside diameter. The threaded fastener includes a threaded section, a head, a shank that couples the threaded section and the head, and an annular ridge that projects from shank. The threaded section and the shank have outside diameters that are less than the inside diameter. The annular ridge includes a first lateral surface that generally confronts the head, a second lateral surface that generally faces the threaded section, and a crest that is spaced along the longitudinal axis between the first and second lateral surfaces. The crest defines a maximum ridge diameter that is greater than the inside diameter of the first end of the helical compression spring. The method includes moving, substantially without interference, away from the threaded section, the first end over the first lateral surface; snapping the first end over the crest; and moving, substantially without interference, toward the head, the first end over the second lateral surface and a portion of the shank.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is plan view of a threaded fastener including a retainer in accordance with the detailed description of a preferred embodiment.

FIG. 2 is a cross-section showing a helical compression spring that may be used with the threaded fastener shown in FIG. 1.

FIG. 3 is a schematic illustration showing a relative position of the threaded fastener shown in FIG. 1 and the helical compression spring shown in FIG. 2, before the helical compression spring is retained with respect to the threaded fastener.

FIG. 4 is a schematic illustration showing a relative position of the threaded fastener shown in FIG. 1 and the helical compression spring shown in FIG. 2, as the helical compression spring is being retained or released with respect to the threaded fastener.

FIG. 5 is a schematic illustration showing a relative position of the threaded fastener shown in FIG. 1 and the helical compression spring shown in FIG. 2, after the helical compression spring is retained with respect to the threaded fastener.

### DETAILED DESCRIPTION OF THE PREFERRED EMBODIMENT

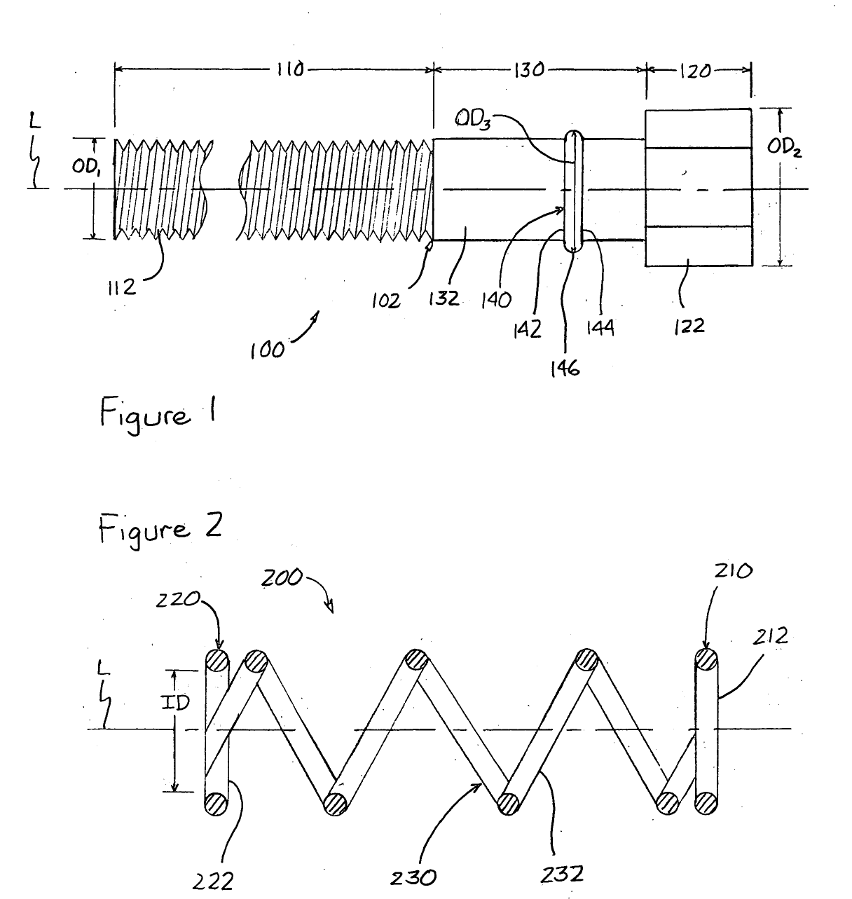

FIG. 1 shows a threaded fastener 100, which can be a screw, bolt, or another type of fastener. The threaded fastener 100 includes a body 102 that extends along a longitudinal axis L between a first end portion 110 and a second end portion 120. According to a preferred embodiment, the first end portion 110 includes at least one thread 112, and the second end portion 120 includes a head 122. The first end portion 110 has a maximum outside dimension OD₁, and the second end portion 120 has a maximum outside dimension OD₂. According to the preferred embodiment, the maximum outside dimension OD₁ represents the diameter of the at least one thread 112, and the maximum outside dimension OD₂ represents the size of the head 122. The maximum outside dimension OD₂ exceeds the maximum outside dimension OD₁.

Extending between and coupling the first and second end portions 110,120 is an intermediate portion 130. According to the preferred embodiment, the intermediate portion 130 includes a shank 132, or unthreaded portion, and the maximum outside dimension OD₁ represents the diameter of the shank 132.

Extending from the intermediate portion 130 is an annular band 140 that a maximum outside dimension OD₃. The maximum outside dimension OD₃ exceeds the maximum outside dimension OD₁, but is less than the maximum outside dimension OD₂. According to a preferred embodiment, the band 140 includes a first lateral face 142 that generally faces the first end portion 110, and includes a second lateral face 144 that generally facing the second end portion 120. Further, according to the preferred embodiment, the first and second lateral faces 142,144 each include respective sloping sections that intersect at a crest 146, which defines the maximum outside dimension OD₃. According to a most preferred embodiment, when viewed in a cross-section including the longitudinal axis L, the -first and second lateral faces 142,144, including their respective sloping sections, define a semi-circle with the crest 146 at the apex of the semi-circle.

FIG. 2 shows a helical compression spring 200 that may be used, according to the present invention, with the threaded fastener 100. The helical compression spring 200 extends along a longitudinal axis L between a first section 210 and a second section 220. According to a preferred embodiment, the first section 210 includes a first generally closed end 212, and the second section 220 includes a second generally closed end 222. As it is used in this description, the phrase “closed end” refers to a nearly circular loop that lies in an imaginary plane that is substantially orthogonal with respect to the longitudinal axis L. According to a preferred embodiment, the first and second generally closed ends 212,222 have a common minimum inside dimension ID. However, the first and second generally closed ends 212,222 can have different minimum inside dimensions so long as both are larger than the maximum outside dimension OD₁, and the minimum inside dimension of the second generally closed end 222 is less than maximum outside dimension OD₂. In practice, the minimum inside dimension ID and the maximum outside dimension OD₃ are cooperatively selected such that there is some interference therebetween, while minimizing the force necessary to push the minimum inside dimension ID through the maximum outside dimension OD₃.

Extending between and coupling the first and second sections 210,220 is an intermediate section 230. According to the preferred embodiment, the intermediate section 230 includes a body 232 having the form of at least a portion of a resilient coil that has a pitch. As it is used in this description, the term “pitch” refers to a count of the number of twists the body 232 makes around longitudinal axis L per unit length of the longitudinal axis L and, in conjunction with the size of the material for the body 232, relates to the spacing along the longitudinal axis L of adjacent twists in the intermediate section 230. According to a preferred embodiment, the intermediate section 230 includes a plurality of twists of the body 232, and has a minimum inside dimension at least as great as the minimum inside dimension ID.

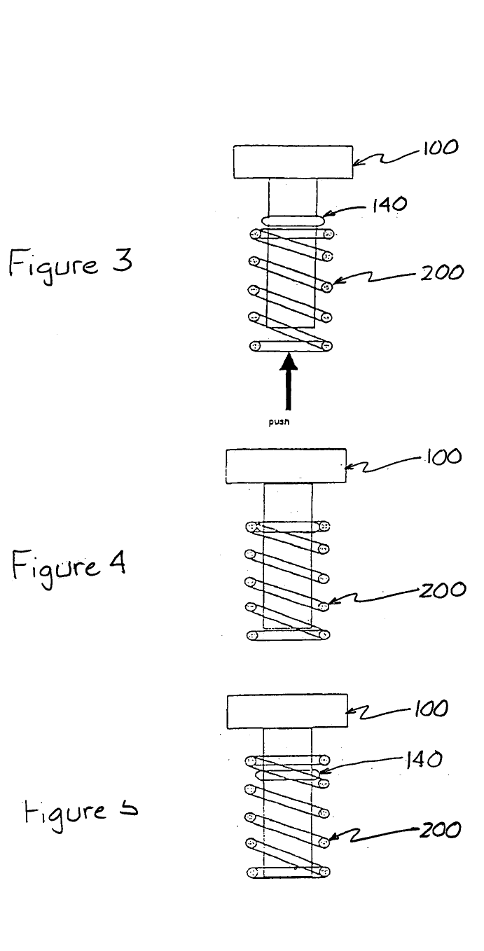

Referring now to FIGS. 3-5, and initially to FIG. 3, the threaded fastener 100 and the helical compression spring 200 are aligned along the longitudinal axis L, and the helical compression spring 200 is displaced along the longitudinal axis L, substantially without interference, so as to surround the first end portion 110. As it is used in this description, the phrase “substantially without interference” refers to relative movement that is not opposed by sliding friction. For example, relative movement substantially without interference would, in the case of relative movement along the longitudinal axis L between the threaded fastener 100 and the helical compression spring 200, occur when there is no engagement or minimal contact between the minimum inside dimension ID and the maximum outside dimension OD₃.

As shown in FIG. 4, as the helical compression spring 200 continues to be displaced along the longitudinal axis L, the first generally closed end 212 engages the band 140 on the intermediate portion 130 of the threaded fastener 100. In particular, the first generally closed end 212 initially engages the sloping section of the first lateral surface 142, and is resiliently expanded as it approaches the crest 146. At the instant that the first generally closed end 212 and the crest 146 are commonly located along the longitudinal axis L, the minimum inside dimension ID of the first generally closed end 212 is approximately the same size as the maximum outside dimension OD₃.

Referring now to FIG. 5, as the helical compression spring 200 continues to be displaced along the longitudinal axis L, substantially without interference, the first generally closed end 212 is loosely retained along the longitudinal axis L between the band 140 and the second end portion 120. As it is used in this description, the term “loosely” refers to allowing appreciable movement. For example, loosely retained would, in the case of the first generally closed end 212, allow appreciable movement along the longitudinal axis L between the band 140 and the second end portion. According to the preferred embodiment, the first generally closed end 212 resiliently contracts as it moves away from the crest 146 and subsequently disengages the sloping section of the second lateral surface 144.

By cooperatively selecting the pitch of the intermediate section 230 such that the spacing along the longitudinal axis L of adjacent twists in the intermediate section 232 is greater than the longitudinal width of the band 140 (measured along the longitudinal axis L between the first and second lateral surfaces 142,144), ensures that there is only one occurrence of the body 232 overlying the band 140.

In order to release the threaded fastener 100 with respect to the helical compression spring 200, the sequence shown and described with respect to FIGS. 3-5 is reversed.

Advantages of the present invention include that the operation of the helical compression spring 200 is unaffected when the helical compression spring 200 is retained on the threaded fastener 100. It is believed that this is at least in part due to the body 232 overlying the band 140 only at one position. Another advantage of the present invention is that, due to the helical compression spring 200 and the threaded fastener 100 being relatively releasable, alternate ones of the helical compression spring 200 can be retained on a single threaded fastener 100. Consequently, it is possible according to the present invention to replace a worn or fatigued helical compression spring with a fresh helical compression spring, and to substitute helical compression springs having different spring rates.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. A retaining system comprising:
a first element including a body extending along a longitudinal axis between first and second end portions, the body having at the first end portion a first maximum outside dimension perpendicular to the longitudinal axis, and having at the second end portion a second maximum outside dimension perpendicular to the longitudinal axis, the second maximum outside dimension being greater than the first maximum outside dimension, and the body including a band generally surrounding the longitudinal axis at an intermediate portion between the first and second end portions, the band having a first, lateral surface generally facing the first end portion, a second lateral surface generally facing the second end portion, and a crest spaced between the first and second lateral surfaces, the crest defining a third maximum outside dimension greater than the first maximum outside dimension and less than the second maximum outside dimension; and
a second element adapted to extend along the longitudinal axis and to surround the body; the second element including a first section proximate the first end portion, a second section adapted to abut the second end portion, and an intermediate section extending between and resiliently coupling the first and second sections, the intermediate section being adapted to overly the band only at one position.

2. The retaining system according to claim 1, wherein the first element comprises a threaded fastener, the first end comprises at least one thread, the second end comprises a head, the intermediate portion comprises a shank, and the band comprises an annular ridge extending from the shank; the first maximum outside dimension comprises a first outside diameter, and the third maximum outside dimension comprises a third outside diameter.

3. The retaining system according to claim 2, wherein the second element comprises a helical compression spring, the first section comprises a generally closed first end lying in a first plane that is substantially orthogonal to the longitudinal axis, the second section comprises a generally closed second end lying in a second plane that is substantially orthogonal to the longitudinal axis, and the intermediate section comprises at least a portion of a coil having a pitch along the longitudinal axis; the first closed end having a first inside diameter greater than the first outside diameter, and the second closed end having a second inside diameter slightly less than the third outside diameter.

4. The retaining system according to claim 3, wherein the coil obliquely overlies the ridge.

5. The retaining system according to claim 3, wherein the band has a longitudinal width between the first and second lateral surfaces, and the longitudinal width of the band is less than the pitch of the coil

6. The retaining system according to claim 2, wherein the ridge extends around the shank substantially orthogonally to the longitudinal axis.

7. A retainer for holding along a longitudinal axis a helical compression spring with respect to a threaded fastener; the helical compression spring including generally closed first and second ends that are generally parallel to one another and including at least a portion of a coil having a pitch along the longitudinal axis and coupling the first and second ends, and the first end having an inside diameter; the threaded fastener including a threaded section, a head, and a shank coupling the threaded section and the head, the threaded section and the shank having outside diameters less than the inside diameter; the retainer comprising:
an annular ridge projecting from shank, the annular ridge including:
a first lateral surface generally confronting the head;
a second lateral surface generally facing the threaded section; and
a crest spaced along the longitudinal axis between the first and second lateral surfaces, the crest defining a maximum ridge diameter greater than the inside diameter of the closed first end.

8. The retainer according to claim 7, wherein the first and second lateral faces are substantially parallel to one another and are substantially orthogonal to the longitudinal axis.

9. The retainer according to claim 7, wherein the annular ridge comprises first and second sloping surfaces, the first sloping surface extending between and coupling the crest and the first lateral surface, and the second sloping surface extending between and coupling the crest and the second lateral surface.

10. The retainer according to claim 9, wherein the first and second sloping surfaces together define a semi-circle when viewed in a cross-section including the longitudinal axis, and the crest defines an apex of the semi-circle when viewed in the cross-section.

11. A method of releasably retaining along a longitudinal axis a helical compression spring with respect to a threaded fastener; the helical compression spring including generally closed first and second ends that are generally parallel to one another and including at least a portion of a coil having a pitch along the longitudinal axis and coupling the first and second ends, and the first end having an inside diameter; the threaded fastener including a threaded section, a head, a shank coupling the threaded section and the head, and an annular ridge projecting from shank, the threaded section and the shank having outside diameters less than the inside diameter, and annular ridge including a first lateral surface generally confronting the head, a second lateral surface generally facing the threaded section, and a crest spaced along the longitudinal axis between the first and second lateral surfaces, the crest defining a maximum ridge diameter greater than the inside diameter of the first end; the method comprising:
moving substantially without interference away from the threaded section the first end over the first lateral surface;
snapping the first end over the crest; and
moving substantially without interference toward the head the first end over the second lateral surface and a portion of the shank.

12. The method according to claim 11, further comprising:
holding loosely the first end between head and the second lateral surface.

13. The method according to claim 11, further comprising:
moving substantially without interference away from the head the first end over the portion of the shank and the second lateral surface;
snapping the first end over the crest; and
moving substantially without interference toward the threaded section the first end over the first lateral surface.

14. The method according to claim 13, further comprising:
moving substantially without interference the first end over threaded section.
